(19) United States
(12) Patent Application Publication
(10) Pub. No.: US 2025/0298926 A1
(43) Pub. Date: Sep. 25, 2025

(54) Managing Document Editing Permissions During Conferences

(71) Applicant: Zoom Communications, Inc., San Jose, CA (US)

(72) Inventors: Annika Victoria Benisano Bautista, New York, NY (US); Michael Dwain Heikka, Port Ludlow, WA (US); Jeffrey William Smith, Layton, UT (US)

(21) Appl. No.: 18/739,990

(22) Filed: Jun. 11, 2024

Related U.S. Application Data
(60) Provisional application No. 63/568,923, filed on Mar. 22, 2024.

(51) Int. Cl. G06F 21/62; G06F 40/166; H04N 7/15

(52) U.S. Cl. CPC G06F 21/629; G06F 40/166; H04N 7/15

(57) ABSTRACT

A server receives an indication of collaborative editing of a document by conference participants of a conference. The server transmits a first request to a document service that manages the document to grant an editing permission to at least one of the conference participants. The server receives an indication to terminate the collaborative editing. In response to the indication to terminate the collaborative editing, the server transmits a second request to the document service to revoke the editing permission from the at least one of the conference participants.

### CROSS REFERENCE TO RELATED APPLICATIONS

This application claims the benefit of U.S. Provisional Patent Application Ser. No. 63/568,923, filed Mar. 22, 2024, the entire disclosure of which is incorporated herein by reference.

### FIELD

This disclosure generally relates to virtual conferences, and, more specifically, to multi-content sharing and collaborative editing in conferences.

### BRIEF DESCRIPTION OF THE DRAWINGS

This disclosure is best understood from the following detailed description when read in conjunction with the accompanying drawings. It is emphasized that, according to common practice, the various features of the drawings are not to scale. On the contrary, the dimensions of the various features are arbitrarily expanded or reduced for clarity.

FIG. 1 is a block diagram of an example of an electronic computing and communications system.

FIG. 2 is a block diagram of an example internal configuration of a computing device of an electronic computing and communications system.

FIG. 3 is a block diagram of an example of a software platform implemented by an electronic computing and communications system.

FIG. 4 is a block diagram of an example of a conferencing system for delivering conferencing software services in an electronic computing and communications system.

FIG. 5 illustrates a block diagram of a system for facilitating multi-content sharing and editing in a video conference.

FIG. 6 is a block diagram of an example of functionality of client conferencing software.

FIG. 7 is a block diagram of an example of functionality of conferencing software.

FIG. 8A illustrates a user interface that enables a presenting participant to select content for sharing in a video conference.

FIG. 8B illustrates a user interface of a file picker that enables a presenting participant to select documents for collaborative editing in a video conference.

FIG. 9A illustrates a user interface displayed by a client conferencing software with respect to collaborative editing in a conference.

FIG. 9B illustrates a user interface that may be displayed by a client conferencing software, depicting a viewing participant's perspective of shared content during a conference.

FIG. 9C illustrates a user interface from the perspective of a presenting participant who is actively sharing content within a video conference.

FIG. 10 is a flowchart of an example of a technique for collaborative document editing in a conference.

FIG. 11 is a flowchart of an example of a technique for collaborative sharing of document in a conference.

### DETAILED DESCRIPTION

Conferencing software is frequently used across various industries to support video-enabled conferences between participants in multiple locations. In some cases, each of the conference participants separately connects to the conferencing software from their own remote locations. In other cases, one or more of the conference participants may be physically located in and connect to the conferencing software from a conference room or similar physical space (e.g., in an office setting) while other conference participants connect to the conferencing software from one or more remote locations. Conferencing software thus enables people to conduct video conferences without requiring them to be physically present with one another. Conferencing software may be available as a standalone software product or it may be integrated within a software platform, such as a unified communications as a service (UCaaS) platform.

A conferencing software may enable a conference participant who is presenting content during a video conference (that participant referred to herein as a “presenting participant”) to share, during a video conference (or, simply, conference), content displayed on a screen of a device used to join the conference. This content sharing capability allows for the dynamic presentation of content, making it possible for the presenting participant to showcase visual aids, documents, software applications, and more. Sharing content by a presenting participant includes sharing a whole display (e.g., all contents displayed on a display screen), a portion of the display (e.g., all content included in a bounding box), or the content of an application window.

Conventional conferencing software approaches restrict content sharing to a single piece of content (e.g., one screen or one application window) at a time during a conference. This restriction poses significant challenges when there is a need to share multiple pieces of content simultaneously. This limitation necessitates cumbersome switching between displays or windows, interrupting the conference flow and potentially causing frustration and confusion among participants. Such a restrictive approach not only disrupts the engagement but also diminishes the overall effectiveness of the conference.

Moreover, when the presenting participant changes the content that is shared, the other conference participants (referred to herein as “viewing participants”) are no longer able to see (such as to further reflect on or analyze) the content that was previously shared. Changing which content is being shared replaces the content being viewed by the viewing participants resulting in frustration, interruptions, and potential confusion negatively affecting the conference experience. The conventional approach of toggling between shared content is not only time-consuming but also hampers the effectiveness of conferences.

Implementations according to this disclosure solve problems such as these by enabling presenting participants to select multiple pieces of content (e.g., displays or windows) for sharing within the conference and enabling both presenting participants and viewing participants to easily switch between shared content. Multi-content sharing enables uninterrupted access to content, enhancing the efficiency and effectiveness of virtual meetings.

Furthermore, as teams become more dispersed and rely heavily on virtual meetings for day-to-day operations, the requirement to seamlessly collaborate on (e.g., review and edit) documents (e.g., text documents, spreadsheets, or presentations, whiteboards, or notes) becomes essential. Real-time document editing facilitates immediate feedback, accelerates decision-making processes, and enhances the overall productivity of the team by allowing multiple participants to contribute, amend, and refine content simultaneously. This capability transforms virtual meetings from passive presentations into dynamic workshops, fostering a more interactive and engaged participation from all attendees.

Facilitating real-time document editing within a conventional virtual conference environment requires a complex orchestration of multiple software tools and platforms. Participants often need to manage separate applications for video conferencing and document editing, navigating between different interfaces to share content and collaborate effectively. This process typically involves pre-meeting preparation such as sharing document links and ensuring all participants have appropriate access permissions. During the meeting, the participants navigate to and open the document so that they can concurrently edit the document. Furthermore, the conventional approach may necessitate the use of screen sharing for visibility, which restricts active participation to a single presenter at a time, limiting the collaborative potential of the meeting.

Implementations of this disclosure also solve problems such as these by integrating the document editing process enabled by a document service in the conferencing process. To facilitate collaboration on a document, a conferencing software interfaces (e.g., integrates) with the document service that manages the document to automatically manage permissions based on conference participation thereby ensuring that all participants can collaboratively edit the document without prior setup. Additionally, a client-side conferencing software integrates (e.g., embeds) a document editor provided by the document service in a user interface associated with the conferencing software thereby streamlining the editing process for the conference participants.

In some implementations, a tabbed interface within the conferencing software enables participants to seamlessly switch between viewing the meeting participants, engage in real-time document editing, and access/view other shared content. As such, the conferencing software removes barriers to effective virtual collaboration thereby enabling fluid and intuitive team interactions.

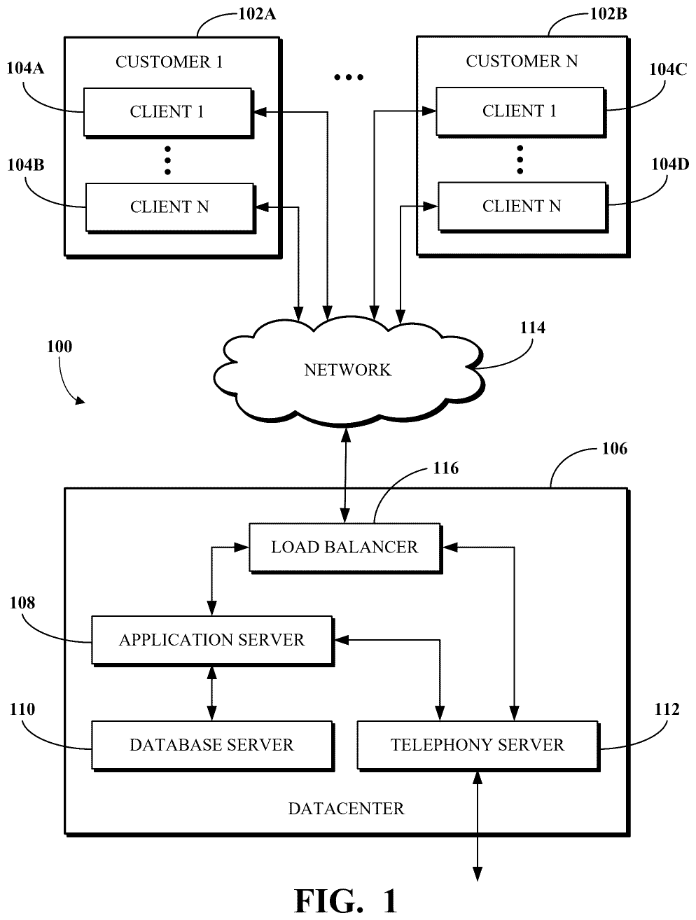

To describe some implementations in greater detail, reference is first made to examples of hardware and software structures used to implement a system for multi-content sharing and collaborative editing in conferences. FIG. 1 is a block diagram of an example of an electronic computing and communications system 100, which can be or include a distributed computing system (e.g., a client-server computing system), a cloud computing system, a clustered computing system, or the like.

The system 100 includes one or more customers, such as customers 102A through 102B, which may each be a public entity, private entity, or another corporate entity or individual that purchases or otherwise uses software services, such as of a UCaaS platform provider. Each customer can include one or more clients. For example, as shown and without limitation, the customer 102A can include clients 104A through 104B, and the customer 102B can include clients 104C through 104D. A customer can include a customer network or domain. For example, and without limitation, the clients 104A through 104B can be associated or communicate with a customer network or domain for the customer 102A and the clients 104C through 104D can be associated or communicate with a customer network or domain for the customer 102B.

A client, such as one of the clients 104A through 104D, may be or otherwise refer to one or both of a client device or a client application. Where a client is or refers to a client device, the client can comprise a computing system, which can include one or more computing devices, such as a mobile phone, a tablet computer, a laptop computer, a notebook computer, a desktop computer, or another suitable computing device or combination of computing devices. Where a client instead is or refers to a client application, the client can be an instance of software running on a customer device (e.g., a client device or another device). In some implementations, a client can be implemented as a single physical unit or as a combination of physical units. In some implementations, a single physical unit can include multiple clients.

The system 100 can include a number of customers and/or clients or can have a configuration of customers or clients different from that generally illustrated in FIG. 1. For example, and without limitation, the system 100 can include hundreds or thousands of customers, and at least some of the customers can include or be associated with a number of clients.

The system 100 includes a datacenter 106, which may include one or more servers. The datacenter 106 can represent a geographic location, which can include a facility, where the one or more servers are located. The system 100 can include a number of datacenters and servers or can include a configuration of datacenters and servers different from that generally illustrated in FIG. 1. For example, and without limitation, the system 100 can include tens of datacenters, and at least some of the datacenters can include hundreds or another suitable number of servers. In some implementations, the datacenter 106 can be associated or communicate with one or more datacenter networks or domains, which can include domains other than the customer domains for the customers 102A through 102B.

The datacenter 106 includes servers used for implementing software services of a

UCaaS platform. The datacenter 106 as generally illustrated includes an application server 108, a database server 110, and a telephony server 112. The servers 108 through 112 can each be a computing system, which can include one or more computing devices, such as a desktop computer, a server computer, or another computer capable of operating as a server, or a combination thereof. A suitable number of each of the servers 108 through 112 can be implemented at the datacenter 106. The UCaaS platform uses a multi-tenant architecture in which installations or instantiations of the servers 108 through 112 is shared amongst the customers 102A through 102B.

In some implementations, one or more of the servers 108 through 112 can be a non-hardware server implemented on a physical device, such as a hardware server. In some implementations, a combination of two or more of the application server 108, the database server 110, and the telephony server 112 can be implemented as a single hardware server or as a single non-hardware server implemented on a single hardware server. In some implementations, the datacenter 106 can include servers other than or in addition to the servers 108 through 112, for example, a media server, a proxy server, or a web server.

The application server 108 runs web-based software services deliverable to a client, such as one of the clients 104A through 104D. As described above, the software services may be of a UCaaS platform. For example, the application server 108 can implement all or a portion of a UCaaS platform, including conferencing software, messaging software, and/or other intra-party or inter-party communications software. The application server 108 may, for example, be or include a unitary Java Virtual Machine (JVM).

In some implementations, the application server 108 can include an application node, which can be a process executed on the application server 108. For example, and without limitation, the application node can be executed in order to deliver software services to a client, such as one of the clients 104A through 104D, as part of a software application. The application node can be implemented using processing threads, virtual machine instantiations, or other computing features of the application server 108. In some such implementations, the application server 108 can include a suitable number of application nodes, depending upon a system load or other characteristics associated with the application server 108. For example, and without limitation, the application server 108 can include two or more nodes forming a node cluster. In some such implementations, the application nodes implemented on a single application server 108 can run on different hardware servers.

The database server 110 stores, manages, or otherwise provides data for delivering software services of the application server 108 to a client, such as one of the clients 104A through 104D. In particular, the database server 110 may implement one or more databases, tables, or other information sources suitable for use with a software application implemented using the application server 108. The database server 110 may include a data storage unit accessible by software executed on the application server 108. A database implemented by the database server 110 may be a relational database management system (RDBMS), an object database, an XML database, a configuration management database (CMDB), a management information base (MIB), one or more flat files, other suitable non-transient storage mechanisms, or a combination thereof. The system 100 can include one or more database servers, in which each database server can include one, two, three, or another suitable number of databases configured as or comprising a suitable database type or combination thereof.

In some implementations, one or more databases, tables, other suitable information sources, or portions or combinations thereof may be stored, managed, or otherwise provided by one or more of the elements of the system 100 other than the database server 110, for example, the client 104 or the application server 108.

The telephony server 112 enables network-based telephony and web communications from and/or to clients of a customer, such as the clients 104A through 104B for the customer 102A or the clients 104C through 104D for the customer 102B. For example, one or more of the clients 104A through 104D may be voice over internet protocol (VOIP)-enabled devices configured to send and receive calls over a network 114. The telephony server 112 includes a session initiation protocol (SIP) zone and a web zone. The SIP zone enables a client of a customer, such as the customer 102A or 102B, to send and receive calls over the network 114 using SIP requests and responses. The web zone integrates telephony data with the application server 108 to enable telephony-based traffic access to software services run by the application server 108. Given the combined functionality of the SIP zone and the web zone, the telephony server 112 may be or include a cloud-based private branch exchange (PBX) system.

The SIP zone receives telephony traffic from a client of a customer and directs same to a destination device. The SIP zone may include one or more call switches for routing the telephony traffic. For example, to route a VOIP call from a first VOIP-enabled client of a customer to a second VOIP-enabled client of the same customer, the telephony server 112 may initiate a SIP transaction between a first client and the second client using a PBX for the customer. However, in another example, to route a VOIP call from a VOIP-enabled client of a customer to a client or non-client device (e.g., a desktop phone which is not configured for VOIP communication) which is not VOIP-enabled, the telephony server 112 may initiate a SIP transaction via a VOIP gateway that transmits the SIP signal to a public switched telephone network (PSTN) system for outbound communication to the non-VOIP-enabled client or non-client phone. Hence, the telephony server 112 may include a PSTN system and may in some cases access an external PSTN system.

The telephony server 112 includes one or more session border controllers (SBCs) for interfacing the SIP zone with one or more aspects external to the telephony server 112. In particular, an SBC can act as an intermediary to transmit and receive SIP requests and responses between clients or non-client devices of a given customer with clients or non-client devices external to that customer. When incoming telephony traffic for delivery to a client of a customer, such as one of the clients 104A through 104D, originating from outside the telephony server 112 is received, an SBC receives the traffic and forwards it to a call switch for routing to the client.

In some implementations, the telephony server 112, via the SIP zone, may enable one or more forms of peering to a carrier or customer premise. For example, Internet peering to a customer premise may be enabled to ease the migration of the customer from a legacy provider to a service provider operating the telephony server 112. In another example, private peering to a customer premise may be enabled to leverage a private connection terminating at one end at the telephony server 112 and at the other end at a computing aspect of the customer environment. In yet another example, carrier peering may be enabled to leverage a connection of a peered carrier to the telephony server 112.

In some such implementations, an SBC or telephony gateway within the customer environment may operate as an intermediary between the SBC of the telephony server 112 and a PSTN for a peered carrier. When an external SBC is first registered with the telephony server 112, a call from a client can be routed through the SBC to a load balancer of the SIP zone, which directs the traffic to a call switch of the telephony server 112. Thereafter, the SBC may be configured to communicate directly with the call switch.

The web zone receives telephony traffic from a client of a customer, via the SIP zone, and directs same to the application server 108 via one or more Domain Name System (DNS) resolutions. For example, a first DNS within the web zone may process a request received via the SIP zone and then deliver the processed request to a web service which connects to a second DNS at or otherwise associated with the application server 108. Once the second DNS resolves the request, it is delivered to the destination service at the application server 108. The web zone may also include a database for authenticating access to a software application for telephony traffic processed within the SIP zone, for example, a softphone.

The clients 104A through 104D communicate with the servers 108 through 112 of the datacenter 106 via the network 114. The network 114 can be or include, for example, the Internet, a local area network (LAN), a wide area network (WAN), a virtual private network (VPN), or another public or private means of electronic computer communication capable of transferring data between a client and one or more servers. In some implementations, a client can connect to the network 114 via a communal connection point, link, or path, or using a distinct connection point, link, or path. For example, a connection point, link, or path can be wired, wireless, use other communications technologies, or a combination thereof.

The network 114, the datacenter 106, or another element, or combination of elements, of the system 100 can include network hardware such as routers, switches, other network devices, or combinations thereof. For example, the datacenter 106 can include a load balancer 116 for routing traffic from the network 114 to various servers associated with the datacenter 106. The load balancer 116 can route, or direct, computing communications traffic, such as signals or messages, to respective elements of the datacenter 106.

For example, the load balancer 116 can operate as a proxy, or reverse proxy, for a service, such as a service provided to one or more remote clients, such as one or more of the clients 104A through 104D, by the application server 108, the telephony server 112, and/or another server. Routing functions of the load balancer 116 can be configured directly or via a DNS. The load balancer 116 can coordinate requests from remote clients and can simplify client access by masking the internal configuration of the datacenter 106 from the remote clients.

In some implementations, the load balancer 116 can operate as a firewall, allowing or preventing communications based on configuration settings. Although the load balancer 116 is depicted in FIG. 1 as being within the datacenter 106, in some implementations, the load balancer 116 can instead be located outside of the datacenter 106, for example, when providing global routing for multiple datacenters. In some implementations, load balancers can be included both within and outside of the datacenter 106. In some implementations, the load balancer 116 can be omitted.

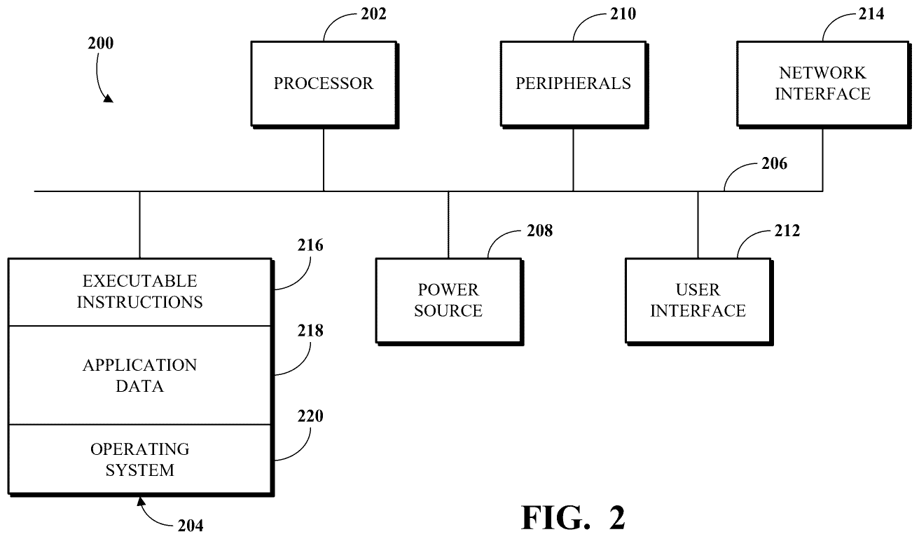

FIG. 2 is a block diagram of an example internal configuration of a computing device 200 of an electronic computing and communications system. In one configuration, the computing device 200 may implement one or more of the client 104, the application server 108, the database server 110, or the telephony server 112 of the system 100 shown in FIG. 1.

The computing device 200 includes components or units, such as a processor 202, a memory 204, a bus 206, a power source 208, peripherals 210, a user interface 212, a network interface 214, other suitable components, or a combination thereof. One or more of the memory 204, the power source 208, the peripherals 210, the user interface 212, or the network interface 214 can communicate with the processor 202 via the bus 206.

The processor 202 is a central processing unit, such as a microprocessor, and can include single or multiple processors having single or multiple processing cores. Alternatively, the processor 202 can include another type of device, or multiple devices, configured for manipulating or processing information. For example, the processor 202 can include multiple processors interconnected in one or more manners, including hardwired or networked. The operations of the processor 202 can be distributed across multiple devices or units that can be coupled directly or across a local area or other suitable type of network. The processor 202 can include a cache, or cache memory, for local storage of operating data or instructions.

The memory 204 includes one or more memory components, which may each be volatile memory or non-volatile memory. For example, the volatile memory can be random access memory (RAM) (e.g., a DRAM module, such as DDR SDRAM). In another example, the non-volatile memory of the memory 204 can be a disk drive, a solid-state drive, flash memory, or phase-change memory. In some implementations, the memory 204 can be distributed across multiple devices. For example, the memory 204 can include network-based memory or memory in multiple clients or servers performing the operations of those multiple devices.

The memory 204 can include data for immediate access by the processor 202. For example, the memory 204 can include executable instructions 216, application data 218, and an operating system 220. The executable instructions 216 can include one or more application programs, which can be loaded or copied, in whole or in part, from non-volatile memory to volatile memory to be executed by the processor 202. For example, the executable instructions 216 can include instructions for performing some or all of the techniques of this disclosure. The application data 218 can include user data, database data (e.g., database catalogs or dictionaries), or the like. In some implementations, the application data 218 can include functional programs, such as a web browser, a web server, a database server, another program, or a combination thereof. The operating system 220 can be, for example, Microsoft Windows®, Mac OS X®, or Linux®; an operating system for a mobile device, such as a smartphone or tablet device; or an operating system for a non-mobile device, such as a mainframe computer.

The power source 208 provides power to the computing device 200. For example, the power source 208 can be an interface to an external power distribution system. In another example, the power source 208 can be a battery, such as where the computing device 200 is a mobile device or is otherwise configured to operate independently of an external power distribution system. In some implementations, the computing device 200 may include or otherwise use multiple power sources. In some such implementations, the power source 208 can be a backup battery.

The peripherals 210 includes one or more sensors, detectors, or other devices configured for monitoring the computing device 200 or the environment around the computing device 200. For example, the peripherals 210 can include a geolocation component, such as a global positioning system location unit. In another example, the peripherals can include a temperature sensor for measuring temperatures of components of the computing device 200, such as the processor 202. In some implementations, the computing device 200 can omit the peripherals 210.

The user interface 212 includes one or more input interfaces and/or output interfaces. An input interface may, for example, be a positional input device, such as a mouse, touchpad, touchscreen, or the like; a keyboard; or another suitable human or machine interface device. An output interface may, for example, be a display, such as a liquid crystal display, a cathode-ray tube, a light emitting diode display, or other suitable display.

The network interface 214 provides a connection or link to a network (e.g., the network 114 shown in FIG. 1). The network interface 214 can be a wired network interface or a wireless network interface. The computing device 200 can communicate with other devices via the network interface 214 using one or more network protocols, such as using Ethernet, transmission control protocol (TCP), internet protocol (IP), power line communication, an IEEE 802.X protocol (e.g., Wi-Fi, Bluetooth, or ZigBee), infrared, visible light, general packet radio service (GPRS), global system for mobile communications (GSM), code-division multiple access (CDMA), Z-Wave, another protocol, or a combination thereof.

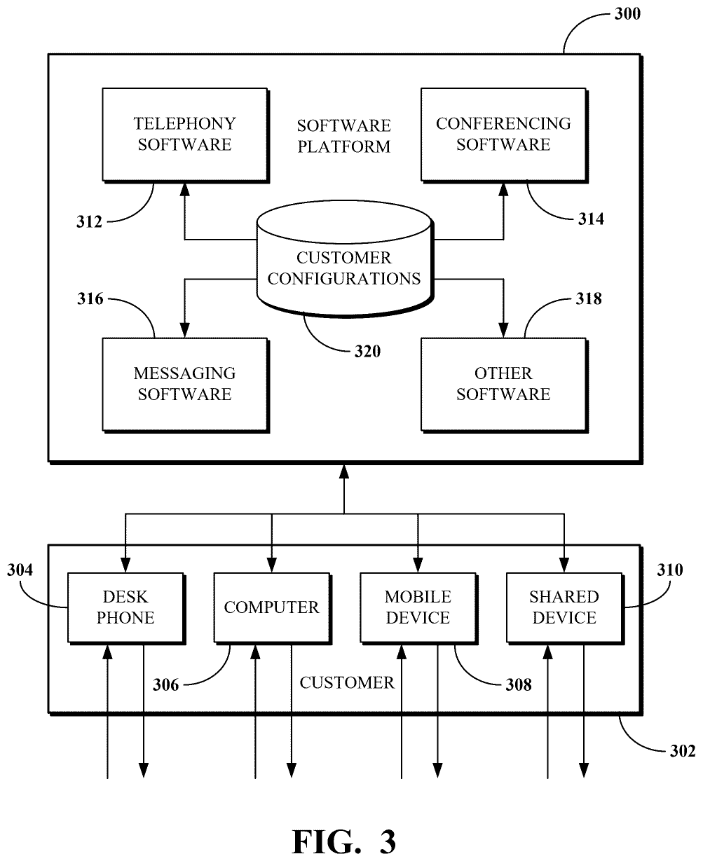

FIG. 3 is a block diagram of an example of a software platform 300 implemented by an electronic computing and communications system, for example, the system 100 shown in FIG. 1. The software platform 300 is a UCaaS platform accessible by clients of a customer of a UCaaS platform provider, for example, the clients 104A through 104B of the customer 102A or the clients 104C through 104D of the customer 102B shown in FIG. 1. The software platform 300 may be a multi-tenant platform instantiated using one or more servers at one or more datacenters including, for example, the application server 108, the database server 110, and the telephony server 112 of the datacenter 106 shown in FIG. 1.

The software platform 300 includes software services accessible using one or more clients. For example, a customer 302 as shown includes four clients-a desk phone 304, a computer 306, a mobile device 308, and a shared device 310. The desk phone 304 is a desktop unit configured to at least send and receive calls and includes an input device for receiving a telephone number or extension to dial to and an output device for outputting audio and/or video for a call that is in progress. The computer 306 is a desktop, laptop, or tablet computer including an input device for receiving some form of user input and an output device for outputting information in an audio and/or visual format. The mobile device 308 is a smartphone, wearable device, or other mobile computing aspect including an input device for receiving some form of user input and an output device for outputting information in an audio and/or visual format. The desk phone 304, the computer 306, and the mobile device 308 may generally be considered personal devices configured for use by a single user. The shared device 310 is a desk phone, a computer, a mobile device, or a different device which may instead be configured for use by multiple specified or unspecified users.

Each of the clients 304 through 310 includes or runs on a computing device configured to access at least a portion of the software platform 300. In some implementations, the customer 302 may include additional clients not shown. For example, the customer 302 may include multiple clients of one or more client types (e.g., multiple desk phones or multiple computers) and/or one or more clients of a client type not shown in FIG. 3 (e.g., wearable devices or televisions other than as shared devices). For example, the customer 302 may have tens or hundreds of desk phones, computers, mobile devices, and/or shared devices.

The software services of the software platform 300 generally relate to communications tools, but are in no way limited in scope. As shown, the software services of the software platform 300 include telephony software 312, conferencing software 314, messaging software 316, and other software 318. Some or all of the software 312 through 318 uses customer configurations 320 specific to the customer 302. The customer configurations 320 may, for example, be data stored within a database or other data store at a database server, such as the database server 110 shown in FIG. 1.

The telephony software 312 enables telephony traffic between ones of the clients 304 through 310 and other telephony-enabled devices, which may be other ones of the clients 304 through 310, other VOIP-enabled clients of the customer 302, non-VOIP-enabled devices of the customer 302, VOIP-enabled clients of another customer, non-VOIP-enabled devices of another customer, or other VOIP-enabled clients or non-VOIP-enabled devices. Calls sent or received using the telephony software 312 may, for example, be sent or received using the desk phone 304, a softphone running on the computer 306, a mobile application running on the mobile device 308, or using the shared device 310 that includes telephony features.

The telephony software 312 further enables phones that do not include a client application to connect to other software services of the software platform 300. For example, the telephony software 312 may receive and process calls from phones not associated with the customer 302 to route that telephony traffic to one or more of the conferencing software 314, the messaging software 316, or the other software 318.

The conferencing software 314 enables audio, video, and/or other forms of conferences between multiple participants, such as to facilitate a conference between those participants. In some cases, the participants may all be physically present within a single location, for example, a conference room, in which the conferencing software 314 may facilitate a conference between only those participants and using one or more clients within the conference room. In some cases, one or more participants may be physically present within a single location and one or more other participants may be remote, in which the conferencing software 314 may facilitate a conference between all of those participants using one or more clients within the conference room and one or more remote clients. In some cases, the participants may all be remote, in which the conferencing software 314 may facilitate a conference between the participants using different clients for the participants. The conferencing software 314 can include functionality for hosting, presenting scheduling, joining, or otherwise participating in a conference. The conferencing software 314 may further include functionality for recording some or all of a conference and/or documenting a transcript for the conference.

The messaging software 316 enables instant messaging, unified messaging, and other types of messaging communications between multiple devices, such as to facilitate a chat or other virtual conversation between users of those devices. The unified messaging functionality of the messaging software 316 may, for example, refer to email messaging which includes a voicemail transcription service delivered in email format.

The other software 318 enables other functionality of the software platform 300. Examples of the other software 318 include, but are not limited to, device management software, resource provisioning and deployment software, administrative software, third party integration software, and the like. In one particular example, the other software 318 can include software that enables multi-content sharing and collaborative editing in conferences. In some such cases, the conferencing software 314 can include the other software 318.

The software 312 through 318 may be implemented using one or more servers, for example, of a datacenter such as the datacenter 106 shown in FIG. 1. For example, one or more of the software 312 through 318 may be implemented using an application server, a database server, and/or a telephony server, such as the servers 108 through 112 shown in FIG. 1. In another example, one or more of the software 312 through 318 may be implemented using servers not shown in FIG. 1, for example, a meeting server, a web server, or another server. In yet another example, one or more of the software 312 through 318 may be implemented using one or more of the servers 108 through 112 and one or more other servers. The software 312 through 318 may be implemented by different servers or by the same server.

Features of the software services of the software platform 300 may be integrated with one another to provide a unified experience for users. For example, the messaging software 316 may include a user interface element configured to initiate a call with another user of the customer 302. In another example, the telephony software 312 may include functionality for elevating a telephone call to a conference. In yet another example, the conferencing software 314 may include functionality for sending and receiving instant messages between participants and/or other users of the customer 302. In yet another example, the conferencing software 314 may include functionality for file sharing between participants and/or other users of the customer 302. In some implementations, some or all of the software 312 through 318 may be combined into a single software application run on clients of the customer, such as one or more of the clients 304 through 310.

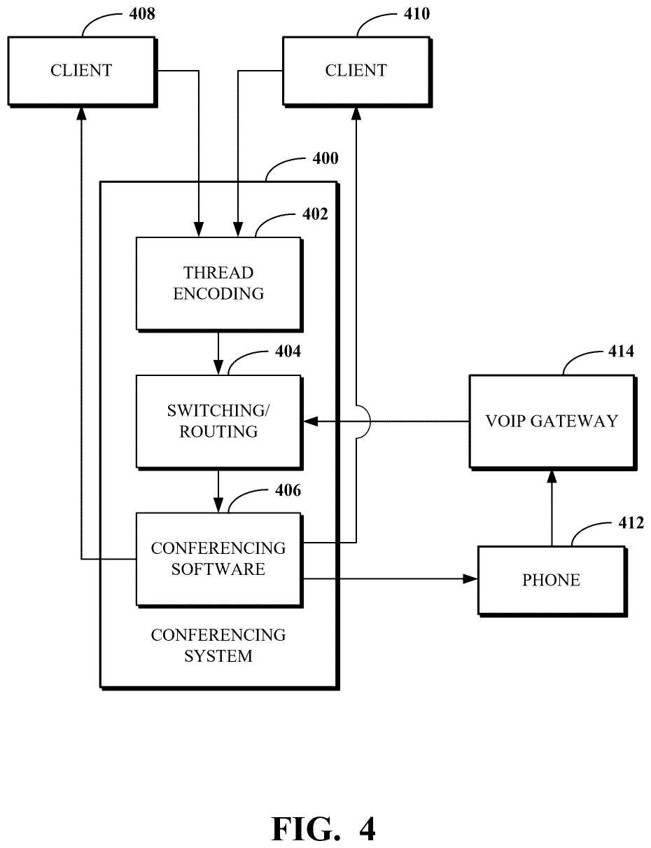

FIG. 4 is a block diagram of an example of a conferencing system 400 for delivering conferencing software services in an electronic computing and communications system, for example, the system 100 shown in FIG. 1. The conferencing system 400 includes a thread encoding tool 402, a switching/routing tool 404, and conferencing software 406. The conferencing software 406, which may, for example, the conferencing software 314 shown in FIG. 3, is software for implementing conferences (e.g., video conferences) between users of clients and/or phones, such as clients 408 and 410 and phone 412. For example, the clients 408 or 410 may each be one of the clients 304 through 310 shown in FIG. 3 that runs a client application associated with the conferencing software 406, and the phone 412 may be a telephone which does not run a client application associated with the conferencing software 406 or otherwise access a web application associated with the conferencing software 406. The conferencing system 400 may in at least some cases be implemented using one or more servers of the system 100, for example, the application server 108 shown in FIG. 1. Although two clients and a phone are shown in FIG. 4, other numbers of clients and/or other numbers of phones can connect to the conferencing system 400.

Implementing a conference includes transmitting and receiving video, audio, and/or other data between clients and/or phones, as applicable, of the conference participants. Each of the client 408, the client 410, and the phone 412 may connect through the conferencing system 400 using separate input streams to enable users thereof to participate in a conference together using the conferencing software 406. The various channels used for establishing connections between the clients 408 and 410 and the phone 412 may, for example, be based on the individual device capabilities of the clients 408 and 410 and the phone 412.

The conferencing software 406 includes a user interface tile for each input stream received and processed at the conferencing system 400. A user interface tile as used herein generally refers to a portion of a conferencing software user interface which displays information (e.g., a rendered video) associated with one or more conference participants. A user interface tile may, but need not, be generally rectangular. The size of a user interface tile may depend on one or more factors including the view style set for the conferencing software user interface at a given time and whether the one or more conference participants represented by the user interface tile are active speakers at a given time. The view style for the conferencing software user interface, which may be uniformly configured for all conference participants by a host of the subject conference or which may be individually configured by each conference participant, may be one of a gallery view in which all user interface tiles are similarly or identically sized and arranged in a generally grid layout or a speaker view in which one or more user interface tiles for active speakers are enlarged and arranged in a center position of the conferencing software user interface while the user interface tiles for other conference participants are reduced in size and arranged near an edge of the conferencing software user interface. In some cases, the view style or one or more other configurations related to the display of user interface tiles may be based on a type of video conference implemented using the conferencing software 406 (e.g., a participant-to-participant video conference, a contact center engagement video conference, or an online learning video conference, as will be described below).

The content of the user interface tile associated with a given participant may be dependent upon the source of the input stream for that participant. For example, where a participant accesses the conferencing software 406 from a client, such as the client 408 or 410, the user interface tile associated with that participant may include a video stream captured at the client and transmitted to the conferencing system 400, which is then transmitted from the conferencing system 400 to other clients for viewing by other participants (although the participant may optionally disable video features to suspend the video stream from being presented during some or all of the conference). In another example, where a participant access the conferencing software 406 from a phone, such as the phone 412, the user interface tile for the participant may be limited to a static image showing text (e.g., a name, telephone number, or other identifier associated with the participant or the phone 412) or other default background aspect since there is no video stream presented for that participant.

The thread encoding tool 402 receives video streams separately from the clients 408 and 410 and encodes those video streams using one or more transcoding tools, such as to produce variant streams at different resolutions. For example, a given video stream received from a client may be processed using multi-stream capabilities of the conferencing system 400 to result in multiple resolution versions of that video stream, including versions at 90p, 180p, 360p, 720p, and/or 1080p, amongst others. The video streams may be received from the clients over a network, for example, the network 114 shown in FIG. 1, or by a direct wired connection, such as using a universal serial bus (USB) connection or like coupling aspect. After the video streams are encoded, the switching/routing tool 404 directs the encoded streams through applicable network infrastructure and/or other hardware to deliver the encoded streams to the conferencing software 406. The conferencing software 406 transmits the encoded video streams to each connected client, such as the clients 408 and 410, which receive and decode the encoded video streams to output the video content thereof for display by video output components of the clients, such as within respective user interface tiles of a user interface of the conferencing software 406.

A user of the phone 412 participates in a conference using an audio-only connection and may be referred to as an audio-only caller. To participate in the conference from the phone 412, an audio signal from the phone 412 is received and processed at a VOIP gateway 414 to prepare a digital telephony signal for processing at the conferencing system 400. The VOIP gateway 414 may be part of the system 100, for example, implemented at or in connection with a server of the datacenter 106, such as the telephony server 112 shown in FIG. 1. Alternatively, the VOIP gateway 414 may be located on the user-side, such as in a same location as the phone 412. The digital telephony signal is a packet switched signal transmitted to the switching/routing tool 404 for delivery to the conferencing software 406. The conferencing software 406 outputs an audio signal representing a combined audio capture for each participant of the conference for output by an audio output component of the phone 412. In some implementations, the VOIP gateway 414 may be omitted, for example, where the phone 412 is a VOIP-enabled phone.

A conference implemented using the conferencing software 406 may be referred to as a video conference in which video streaming is enabled for the conference participants thereof. The enabling of video streaming for a conference participant of a video conference does not require that the conference participant activate or otherwise use video functionality for participating in the video conference. For example, a conference may still be a video conference where none of the participants joining using clients turns on their video stream for any portion of the conference. In some cases, however, the conference may have video disabled, such as where each participant connects to the conference using a phone rather than a client, or where a host of the conference selectively configures the conference to exclude video functionality.

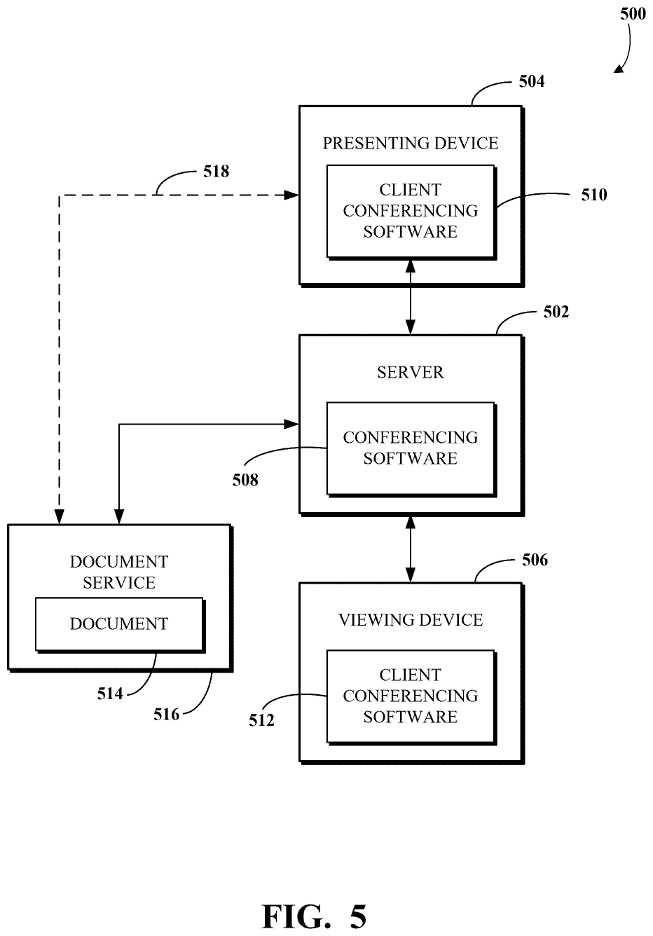

FIG. 5 illustrates a block diagram of a system 500 for facilitating multi-content sharing and editing in a video conference. The system 500 includes a server 502 and two participant devices that are connected to the video conference (or, simply, conference). The participant devices include a presenting device 504 and a viewing device 506. The presenting device 504 and the viewing device 506 establish respective connections to the video conference hosted or enabled by conferencing software 508 operating on the server 502. The conferencing software 508 can be the conferencing software 406 shown in FIG. 4.

Although only two participant devices are shown in FIG. 5, the system 500 can accommodate a significantly larger number of devices (or, equivalently, conference participants), potentially engaging in multiple concurrent video conferences hosted by the server 502. It is also noted that the roles of devices within this system are interchangeable. That is, a viewing device can itself also be, concurrently or at a different time, a presenting device, and vice versa. The presenting device 504 includes a client conferencing software 510 (introduced below). If content is shared from a device, then it is referred to as a presenting device with respect to the content shared from that device and the other devices are referred to as viewing devices. As such, a presenting device can also be a viewing device with respect to content shared by another device.

The viewing device 506 includes a client conferencing software 512, which can be the same or similar to the client conferencing software 510. That is, the client conferencing software 512 may implement features similar to those described herein with the client conferencing software 510, and vice versa. Each of the presenting device 504 and the viewing device 506 may, for example, be one of the clients 408 or 410 shown in FIG. 4.

The presenting device 504 is associated with a presenting participant who shares, in the video conference (e.g., with the other participants), content shown on (e.g., output to) a display of the presenting device 504. The presenting device 504 may include or be connected to one or more displays, which may be as described with respect to the output interfaces of FIG. 2. One or more applications may be executing at the presenting device 504 such that the applications display respective user interfaces in windows on the displays.

The presenting device 504 connects to the video conference using the client conferencing software 510. The client conferencing software 510 may, for example, be a desktop software application, mobile application, or web application associated with one or more services of a software platform, for example, the software platform 300 shown in FIG. 3. In such a case, the server 502 may be a computing device used to implement one or more software services of the software platform, for example, services corresponding to one or more of the software 312 through 318 shown in FIG. 3. For example, the client conferencing software 510 may be software that allows a user of the presenting device 504 to access or otherwise use one or more of the software 312 through 318. As such, the client conferencing software 510 can be or can be included in a client, such the client 408 or the client 410 of FIG. 4.

The client conferencing software 510 can be used by the presenting participant to share content to the video conference. To illustrate, the presenting participant may select one or more of displays of the presenting device 504 for sharing to the video conference. For each content to be shared, the client conferencing software 510 may transmit a corresponding content stream of the content to the conferencing software 508, which in turn transmits the received content streams to the viewing device 506. The client conferencing software 512 enables a viewing participant associated with the viewing device 506 to, for example, select which of the received content streams to display at the viewing device 506.

The client conferencing software 510 may transmit separate content streams corresponding to different shared contents. Alternatively, the client conferencing software 510 may transmit the multiple content streams in a single content stream. For example, the client conferencing software 510 may segment each content feed corresponding to a shared content into packets and interleave these packets within the single content stream, each packet uniquely identifiable as belonging to a specific content stream. Along with the video packets, metadata can be transmitted that enable the server 502 and/or the viewing device 506 to identify and select individual streams. The metadata can include information such as content stream identifiers, timestamps, and, optionally, thumbnail previews. As further described herein, the server 502 may, for example, selectively re-transmit different subsets of the received content streams to different viewing devices.

The conferencing software 508 enables multiple participants to simultaneously share content during the video conference, thereby facilitating a collaborative and interactive environment. Equivalently, or said another way, the conferencing software 508 enables multiple devices connected to the video conference to simultaneously have contents associated therewith (e.g., displayed thereat) shared to the video conference.

The client conferencing software 510 may also enable the presenting participant to initiate and terminate collaborative editing of a document 514 in the video conference. That is, the presenting participant can share the document 514 for real-time, simultaneous editing or viewing by other participants within the conference, such as the viewing participant associated with viewing device 506.

The document 514 can be any type of viewable, reviewable, or editable content managed by a document service 516 that enables simultaneous access by multiple users based on their respective permissions with respect to the document 514. The document 514 can be any type of viewable, reviewable, or editable document. A reviewable document is a file or set of data that can be examined and commented on by one or more conference participants. With respect to an editable document, conference participants can be enabled to directly alter, add, or delete content within the document 514. To illustrate, and without limitations, the document can be a word processing document, a spreadsheet, a presentation, or a whiteboard.

The document can be managed by (e.g., stored in), and accessible from, the document service 516. To illustrate, the document service 516 may be Google Docs™, Microsoft Office Online™, Dropbox Paper™, Microsoft SharePoint™, Microsoft OneDrive™, or some other document service. In an example, the document service 516 may be associated with the conferencing software 508. For example, the document service 516 may be a whiteboard software that may be or may be included in the other software 318 of the software platform 300 of FIG. 3.

The conferencing software 508 may facilitate the collaborative editing of documents by integrating with the document service 516 via an interface (e.g., a programmatic or a communication interface) of the document service 516 that enables the presenting participant to select the document from the document service 516. The conferencing software 508 may interface with the document service 516 to request and assign an editing permission for at least some of the other participants of the video conference. The conferencing software 508 can cause the client conferencing software (e.g., the client conferencing software 512) to display the document at a viewing device and at the presenting device. At the end of the collaborative editing session, the conferencing software 508 may interface with the document service 516 to reset the permissions of the document. In some implementations, the client conferencing software 510 may perform such functions (e.g., may communicate with the document service 516), as illustrated by an arrow 518.

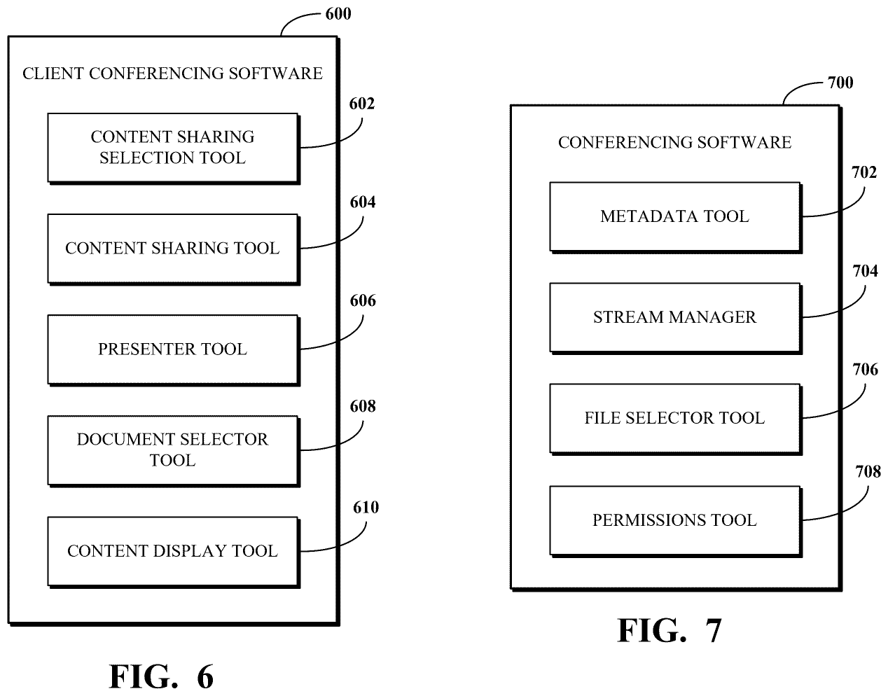

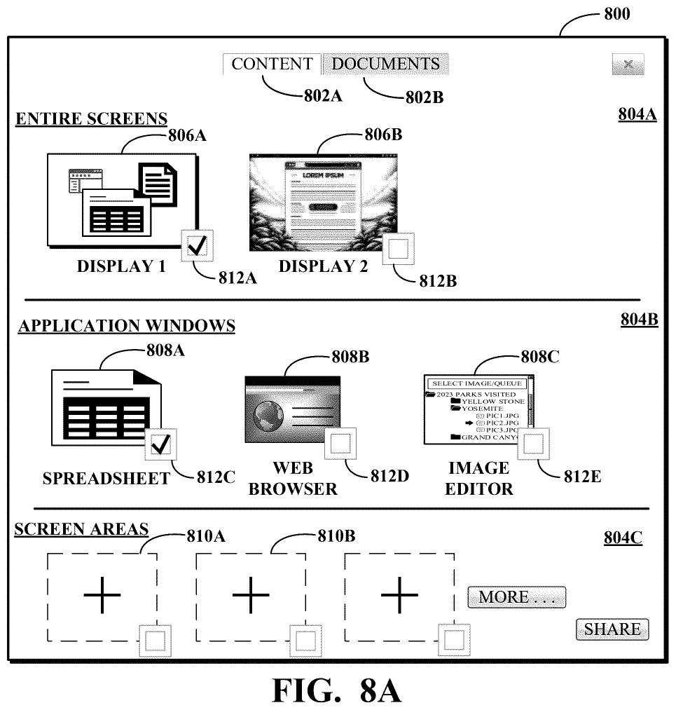

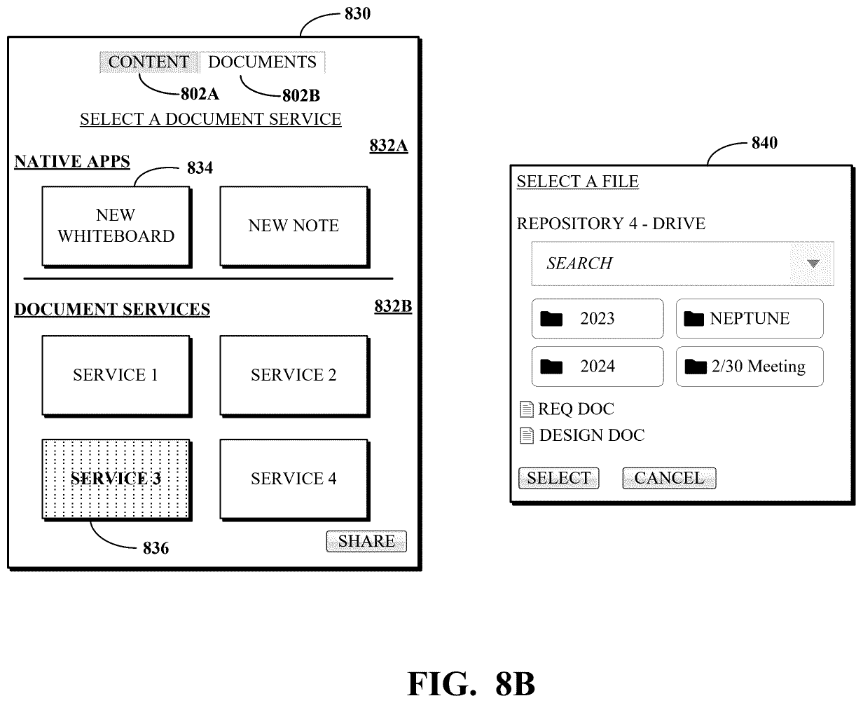

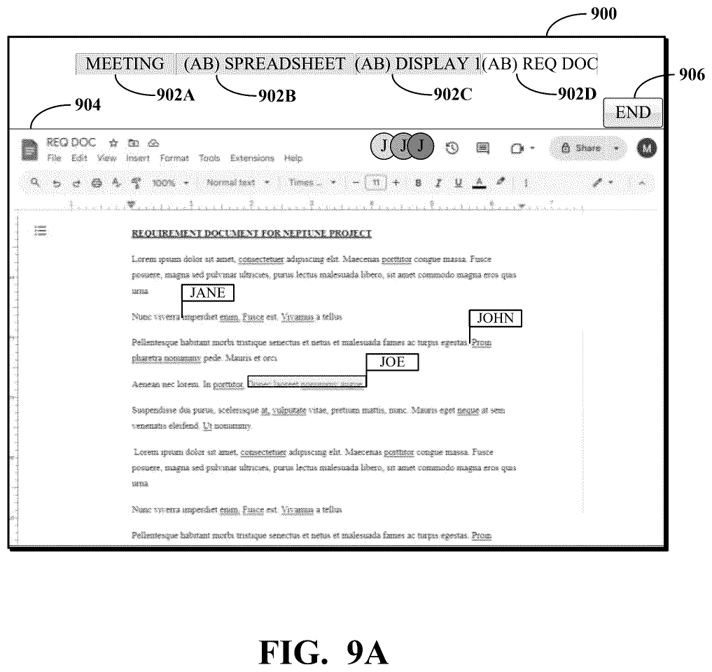

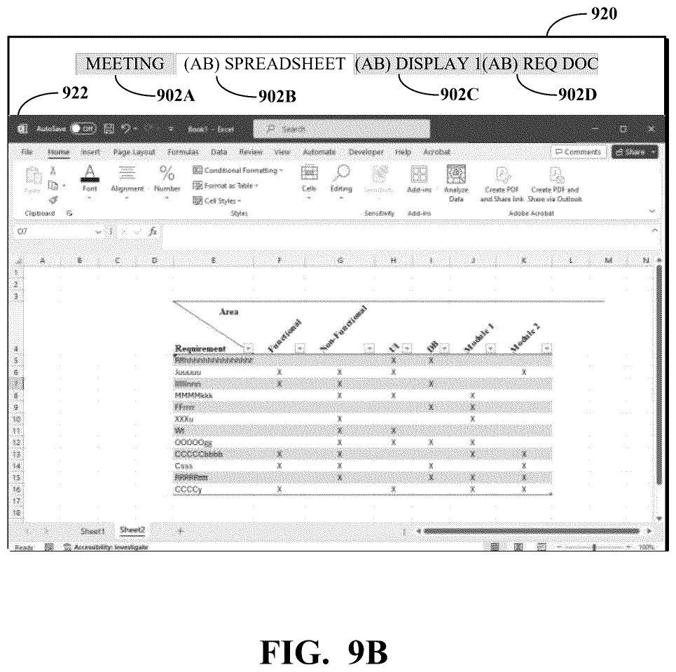

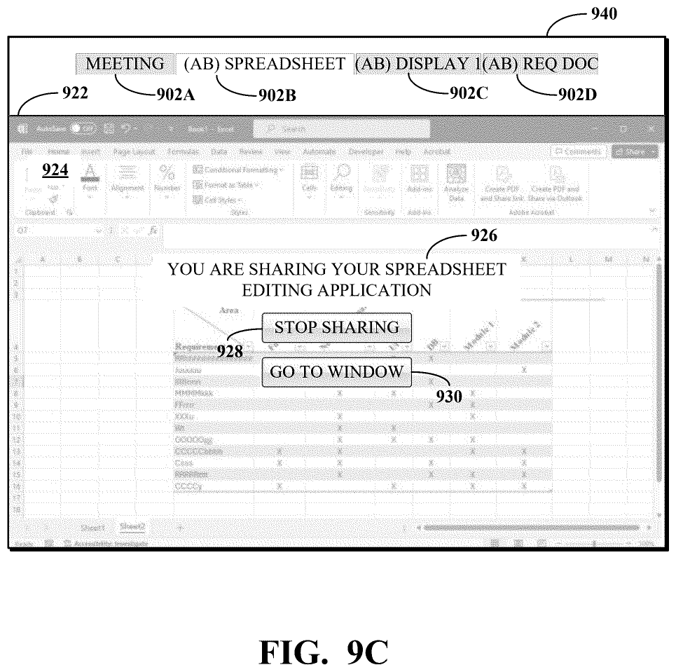

FIG. 6 is a block diagram of an example of functionality of client conferencing software 600 that may be included in a client device, such as the presenting device 504 or the viewing device 506 of FIG. 5. As such, the client conferencing software 600 can be the client conferencing software 510 or the client conferencing software 512 shown in FIG. 5. The client conferencing software 600 includes tools, such as programs, subprograms, functions, routines, subroutines, operations, and/or the like for sharing multiple displays to a conference. As shown, the client conferencing software 600 includes a display sharing selection tool 602, a content sharing tool 604, a presenter tool 606, a document selector tool 608, and a content display tool 610. The operations of the client conferencing software 600 are further described with respect to FIGS. 8A-9C.

The display sharing selection tool 602 enables a presenting participant associated with a presenting device (e.g., the presenting devices 504) to select sharable content (e.g., content displayed at or accessible by the presenting device) for sharing in a conference.

The content sharing tool 604 facilitates a screen share of content during the video conference from the presenting device to viewing devices (e.g., the viewing device 506 of FIG. 5). In particular, the content sharing tool 604 transmits respective content streams of the shared content. Each content stream may correspond to a distinct shared content. The video streams are transmitted to a conferencing software (e.g., the conferencing software 508 of FIG. 5), which in turn transmits the content streams to other the viewing devices.

The presenter tool 606 enables a participant to request presenter role. In response to the request, the presenter tool 606 transmits a request to the conferencing software to designate the participant as the primary presenter. While one participant may be designated as a primary presenter, other conference participants may continue to have respective content shared to the conference.

The document selector tool 608 may be configured to integrate with various document services. The document selector tool 608 enables a presenting participant to select a document (e.g., the document 514 of FIG. 5) from the document service (e.g., the document service 516 of FIG. 5) so that the document can be collaboratively edited (or at least opened) in a video conference. The document selector tool 608 can launch, or can cause the conferencing software of a server (such as the conferencing software 508 of FIG. 5) to launch, a file selector of the document service such that the file selector is displayed at the presenting device, such as directly from within the client conferencing software 600.

In some implementations, all conference participants are granted editing permission to edit the document. In some implementations, the document selector tool 608 (in conjunction with the permission tool 708 of FIG. 7) enables the presenting participant to specify different permissions with respect to the document for different conference participants. For example, the document selector tool 608 may enable the presenting participant to associate an editing permission with a subset of the conference participants, a reviewing permission with another subset of the conference participants, and/or a viewing permission with yet another subset. This is achieved by facilitating communication between the client conferencing software 600 and the conferencing software at the server, which in turn interacts with the document service to configure the permissions. Additionally, the presenting participant can manage permissions dynamically, granting or revoking editing access to certain of the conference participants, thereby controlling the collaborative experience in real-time.

The content display tool 610 is configured to manage and display various content streams received from the different presenting devices where the content streams are received via a server-side conferencing software (e.g., the conferencing software 508 of FIG. 8). Each piece of shared content, received at the client device as a distinct stream, can be presented within a corresponding user interface of the client conferencing software 600. The content display tool 610 supports a dynamic, multi-faceted viewing experience by enabling the conference participants to switch viewing between different content streams seamlessly.

The content display tool 610 is also configured to display the shared document in a user interface of the client conferencing software 600. To illustrate, once a document is shared, the document may appear within a dedicated tab of a tabbed user interface associated with the client conferencing software 600 of each device of a conference participant.

The content display tool 610 may receive an identifier of the document to be shared. The identifier may be a link (e.g., a Uniform Resource Locator (URL)) to the document to be collaboratively edited. The identifier may include a file name (e.g., a file path) and an identifier of the document service that manages the document. The content display tool 610 may create a container within a user interface associated with the client conferencing software 600. The container is designated for rendering the document provided by the document service. To illustrate, and without limitations, the container can be implemented as an inline frame (iframe), which is a Hypertext Markup Language (HTML) element that enables an external webpage to be embedded within an existing webpage, a panel or a tab within desktop applications, or a Web View in mobile applications, allowing for the embedding of web-based documents directly within the user interface of the conferencing application associated with the client conferencing software 600. For example, the user interface may be a desktop application and the container can be an embedded web browser. Other implementations are possible. As such, the content display tool 610 can have programmatic control over the container object. For example, when collaborative editing is ended, the content display tool 610 can destroy (e.g., close) the container.

FIG. 7 is a block diagram of an example of functionality of conferencing software 700, which may, for example, be the conferencing software 508 of FIG. 5 shown in FIG. 5. The conferencing software 700 includes tools, such as programs, subprograms, functions, routines, subroutines, operations, and/or the like for enabling multiple conference participants to simultaneously share displays in a video conference. As shown, the conferencing software 700 includes a metadata tool 702, a stream manager tool 704, a file selector tool 706, and a permissions tool 708.

The metadata tool 702 receives from each presenting device metadata associated with content shared at that presenting device. The metadata may include respective identifiers for the shared content (e.g., the video streams associated therewith). The metadata tool 702 transmits, to each viewing device, metadata describing the shared content at the presenting devices. That is, the metadata tool 702 aggregates all the metadata received from the presenting devices for transmission to the viewing devices thereby enabling viewing participants to know which streams are available for selection and/or view.

A presenting device may transmit the metadata to the conferencing software 700 when a change in which content are shared occurs. The metadata tool 702 transmits metadata to the viewing devices when a change in the shared content is identified based on the received metadata.

The stream manager tool 704 manages (e.g., orchestrates) the flow of content streams from presenting devices to viewing devices. The stream manager tool 704 receives content streams from presenting devices and may determine which streams to forward to which viewing devices based on content streams selected for receipt, or currently visible, at those viewing devices. In an example, if no specific selection of a subset of the content streams is received from a viewing device, then the stream manager tool 704 may be configured to transmit all received content streams to that viewing device. In another example, if no specific selection of a subset of the content streams is received from a viewing device, the stream manager tool 704 may be configured to only transmit the content stream associated with a shared content currently showing at the presenting device of a current presenting participant. In another example, the stream manager tool 704 may be configured to transmit to a viewing device a stream corresponding to a currently viewable content stream at that viewing device.

To illustrate, and with reference to FIGS. 9A-9B, which are further described below, the currently viewable content in FIG. 9A corresponds to the tab 902D and the viewable content in FIG. 9B corresponds to the tab 902B. In response to a change in the active tab, the client conferencing software transmits an indication of the currently viewable content stream to the conferencing software 700 so that the stream manager tool 704 can start transmitting that stream and stop transmitting other streams to the viewing device.

The file selector tool 706 is configured to interface with various document services to enable a document selection process within a video conference. The file selector tool 706 interfaces with APIs of a document service to facilitate the seamless selection of a document managed by the document service for collaborative editing within a video conference. The file selector tool 706 triggers the document selector of the document service enabling the presenting participant to choose a document to be collaboratively edited or shared amongst conference participants.

The file selector tool 706 bridges the gap between a conferencing software (e.g., a client conferencing software) and external document services facilitating, for the presenting participant, access to and the sharing of documents without leaving the conference environment. Via the integration between the conferencing software and the document service, the file selector tool 706 facilitates a streamlined, integrated collaborative experience, making the collaborative document editing process efficient within the video conference setting. In some implementation, the client conferencing software 600 of FIG. 6 may include or implement the file selector tool 706.

The permissions tool 708 operates to manage and control access permissions for documents selected for collaborative editing or viewing in a video conference. Once a document is chosen through the file selector tool 706, the permissions tool 708 communicates (such as via APIs) with the corresponding document service to grant (e.g., to request the granting of) or revoke (e.g., to request the revocation of) permissions to specified conference participants with respect to the selected document. The specified conference participants may be all conference participants. The specified conference participants may be a subset of the conference participants designated (e.g., selected) by the presenting participant, as described above. The permissions tool 708 can dynamically manage (e.g., modify) document access during a conference. In some implementation, the client conferencing software 600 of FIG. 6 may include or implement the permissions tool 708.

Prior to requesting changes to the permissions of a document, the permissions tool 708 may query the document service for original (e.g., initial or current) permissions of the selected participants with respect to the document. In response to determining an end to the collaborative editing session, the permissions tool 708 may interface with the document service to reset (e.g., revert) the permissions to their original state. The collaborative editing session may be determined to have ended when the video conference ends, in response to the presenting participant explicitly ending the collaborative editing session while the conference is ongoing, or based on some other condition.

The permissions tool 708 may enable role-based access control (RBAC) to provide varying levels of access to a document during collaborative editing. To illustrate, the permissions tool 708 may enable the assignment of different roles with respect to the document. The roles may include ‘Editor,” ‘Reviewer,’ or ‘Viewer,’ each having specific permissions. The permissions tool 708 communicates with the document service to configure (e.g., enforce) these roles dynamically during the conference.

The permissions tool 708 may be configured to enable a presenting participant to select a document for collaborative editing if that participant has such permissions to the document to be able to grant permissions, such as edit permissions, to other participants. When requests are transmitted to the document service to add or revoke permissions from other participants with respect to a document, the requests can be submitted on behalf of the presenting participant. That is, the identity (e.g., credentials) of the presenting participant is used (e.g., is included in Application Programming Interface (API) calls to the document service) to authorize the permission changes. Accordingly, in some implementations, only those files that satisfy such criteria may be displayed in the file selector 706. That is, only those files to which the presenting participant has permissions to modify permissions may be displayed in the file selector. The conferencing software 700 may cause the document service to display in the file selector 706 only those files that meet such criteria. In another example, all available files may be shown. But if the presenting participant does not select a document that meets such criteria, then an error notification can be displayed, and the file is not selected for collaborative editing.

In some implementations, the conferencing software 700 may transmit a request to the document service to cause the document service to generate a backup copy of the document prior to the start of the collaborative editing. In an example, the document service may support version control. Thus, the conferencing software 700 can transmit a request to the document service to create a new version such that the previous version serves as the backup. In either case, the conferencing software 700 is said to transmit a backup request to the document service, which causes the document service to create a copy or a version of the document. As such, the conferencing software 700 can provide a fallback mechanism that enables the conference participants to revert to a previous version of the document in case of data inconsistency. As also mentions conferencing software 700 can store a history of permissions, allowing permission states to be reset to their original values.

FIG. 8A illustrates a user interface 800 that enables a presenting participant to select content for sharing in a video conference. The user interface 800 can be presented (e.g., generated) by a client conferencing software, such as the client conferencing software 600 of FIG. 6, and displayed on a presenting device such as the presenting device 504 of FIG. 5. The user interface 800 is configured as a tabbed layout that includes a category 802A (labeled “CONTENT”) and a category 802B (labeled “DOCUMENTS”) with the category 802A tab being selected.

The category 802A includes sharable content that the presenting participant can select from. A sharable content can be an entire screen content, individual application window, or content of a portion of a screen that can be shared during a video conference. As such, within the category 802A, the user interface 800 includes three primary content selection options divided into a section 804A (labeled “ENTIRE SCREENS”), a section 804B (labeled “APPLICATION WINDOWS”), and a section 804C (labeled “SCREEN AREAS”).

The section 804A illustrates that two displays (e.g., monitors) are attached to the presenting device. The section 804A includes preview thumbnails 806A and 806B of the content displayed at each of the displays. However, more or fewer displays may be attached to the presenting device. The section 804B includes preview thumbnails representing individual application windows of applications executing at the presenter. As illustrated, the section 804B includes preview thumbnails 808A, 808B, and 808C, representing, respectively, a spreadsheet application window, a web browser window, and an image editor window.

The section 804C provides tools, such as tools 810A and 810B, for the presenting participant to share content from selected areas of a display. Via one of these tools the presenting participant can draw a bounding box directly on a display, defining the area whose content is to be shared to the conference. The tools 810A and 810B can be graphical selectors that can be manipulated to adjust the size and position of the bounding box, thus allowing the presenting participant to customize exactly which portion of the screen is visible to other participants in the video conference.

Each sharable content selection, whether it be a full display, an application window, or a user-defined screen area, is accompanied by a corresponding selector (e.g., selectors 812A-812E) which the presenting participant can activate (e.g., select) to share the associated sharable content in the video conference. The selectors enable the presenting participant to easily manage which content is being shared and ensure that only the intended information is transmitted to the viewing participants.

FIG. 8B illustrates a user interface of a file picker 830 that enables a presenting participant to select documents for collaborative editing in a video conference. The file picker 830 can be presented (e.g., generated) by a client conferencing software, such as the client conferencing software 600 of FIG. 6, and displayed on a presenting device such as the presenting device 504 of FIG. 5. The file picker 830 is configured with the tabbed layout described with respect to FIG. 8A.

The category 802B includes a document service area 832A and a document service area 832B. The document service area 832A presents options for creating or opening documents through native applications, such as a whiteboard or note-taking app, as shown by the “NEW WHITEBOARD” and “NEW NOTE” selections. A native application, as used herein, can be an application or software that works in conjunction with the conference software. For example, a native application may be implemented by the software platform 300 of FIG. 3 and may be or may be included in the other software 318 of FIG. 3. In response to the presenting user selecting an option 834, the presenting participant can select an existing whiteboard or cause a new whiteboard to be created for sharing in the video conference for collaborative editing by at least some of the conference participants.

The document service area 832B lists various available document services (e.g., document storage systems) such as “SERVICE 1” and “SERVICE 2,” through which the presenting participant can navigate to select a document stored in one of these repositories. The document services can be or include cloud-based services (e.g., platforms). As mentioned, integrating the conferencing system with document services, such as document storage systems, provides a streamlined workflow for accessing and sharing documents without leaving the conferencing application.

FIG. 8B illustrates that the presenting participant has selected a document service 836. In response to selecting the document service 836, the conferencing software, via APIs of the document service, causes a file picker 840 of the document service 836 to be presented so that the presenting participant can select a file to share for collaborative editing. The document picker 840 includes a list of available documents for collaborative editing. Once a document is selected for sharing, the document becomes part of the collaborative session, accessible for interaction by all authorized conference participants. While not specifically shown, the presenting participant may be able to associate different permissions with different conference participants, as described above. As described above, in some examples, only those files to which the presenting participant has permissions to modify permissions may be shown in the file picker 840.

While not specifically shown in FIG. 8B, in some implementations, the conferencing participant may enable editing of certain sections of the selected document. Via user interfaces, the conference participant may cause the selected document to open and select one or more portions thereof to limit editing permissions to those sections. An input mechanism, such as a bounding box selector or a hierarchical content tree, may be provided to the conference participant to select and restrict editing to desired sections of the document. The bounding box selector enables participants to draw an adjustable box directly over the document's content displayed in the user interface, thus defining a custom region for editing. Alternatively, the hierarchical content tree may present a structured view of the document, allowing participants to enable or disable editing permissions at the section, chapter, or paragraph level.

Once the desired sections are selected, the conferencing software may communicate with the document service via an API to enable modify permissions specifically for the selected sections. This communication ensures that the selected conference participants can only edit the specified regions while viewing the rest of the document in a read-only mode. The document service may maintain a mapping of each participant's permissions and continuously verifies access rights whenever an editing operation is performed.

The document service may provide real-time visual indicators that identify sections available for editing by highlighting them with a distinct color or border. To illustrate, and without limitations, a participant granted editing permissions might see an editable section highlighted in green, while read-only sections are displayed with a grey border. This intuitive feedback helps participants understand the extent of their editing capabilities.

To further facilitate collaboration, the conferencing software may also enable a “suggestion mode,” where participants can propose changes to sections outside their editing permissions. These suggestions appear as inline comments or proposed edits that require approval from authorized participants. The document service handles this workflow by notifying the authorized editors of pending suggestions and allowing them to accept or reject changes directly within the conferencing software.

FIG. 9A illustrates a user interface 900 displayed by a client conferencing software with respect to collaborative editing in a conference. The user interface 900 illustrates what may be displayed at respective devices of conference participants of a conference when one or more sharable contents and one or more documents have been shared for collaborative editing. The user interface 900 is configured with a series of tabs, each corresponding to a different aspect or type of shared content within the conference. However, the disclosure herein is not limited to or by any particular user interface arrangements or controls and others are possible.

A tab labeled 902A corresponds to a “Meeting” view, which presents a gallery view of the conference participants. The gallery view can be a grid-like visual arrangement where each conference may be represented, such as by a square (e.g., tile). Each tile includes a digital representation of a corresponding conference participant. For example, if one conference participant has enabled a camera of their device, then their digital representation can be the video feed obtained from the camera; if another participant has not enabled their camera, then their digital representation may be a textual label (such as their name).

Tabs 902B and 902C correspond to other shared content streams received at the device. For example, the tabs 902B and 902C may correspond, respectively, to the content streams associated with preview thumbnails 808A and 806A of FIG. 8A. Each tab can include an indication of the participant sharing the content shown in the tab. For example, the “AB” in tabs 902B-902C indicate that these content are shared by the participant with the initials “AB.”

In the user interface 900, a tab 902D, labeled “REQ DOC,” is the currently active tab. The tab 902D, when active (e.g., selected), shows a container 904 that includes the currently shared document titled “REQUIREMENT DOCUMENT FOR NEPTUNE PROJECT,” which may correspond to the document selected as described with respect to FIG. 8B. FIG. 9A illustrates that there are multiple contributors currently editing the document, as denoted by the presence of different cursor or text selection indicators labeled “JANE,” “JOHN,” and “JOE,” actively editing the document. The container 904 can be used by the document service to render a user interface for collaborative editing of the document.

While not specifically shown in the FIG. 9A, prior to creating the container for displaying the document, the viewing participant may be required to authenticate with the document service. For example, when the viewing participant initially selects the tab 902D, an authentication user interface of the document service may be presented requesting the viewing participant to authenticate.

A control 906, when invoked, causes the collaborative editing session to terminate. Terminating the collaborative editing session causes a termination request to be transmitted to the respective devices of the conference participants. In response to receiving a termination request at a client device, a respective client conferencing software (e.g., the client conferencing software 600 of FIG. 6) causes the container 904 displayed therein to be closed (e.g., destroyed).

In some implementations, the conferencing software may provide (e.g., display) a confirmation prompt to the conference participants before terminating the collaborative editing session. Such prompts help prevent accidental termination by requiring participants to confirm their intention to end the session. The conferencing software may proceed with terminating the session upon receiving positive confirmation from the conference participants. In another example, the confirmation prompts may include countdown timers, giving the conference participants a limited amount of time (e.g., 10 seconds) to cancel the termination before termination automatically proceeds.

FIG. 9B illustrates a user interface 920 that may be displayed by a client conferencing software, depicting a viewing participant's perspective of shared content during a conference. The shared content illustrated in the user interface 920 is a window of a spreadsheet editing application. The user interface 920 includes tabs 902A-902D, which are described with respect to FIG. 9A. As already mentioned, these tabs allow the participant to easily switch their focus between different shared content sources or collaborative documents.

The user interface 920 illustrates that the viewing participant has selected the tab 902B. The tab 902B is labeled “(AB) SPREADSHEET” illustrating that the shared content displayed is shared by a presenting participant whose initials are “AB” and that the content corresponds to the spreadsheet editing application. The shared content is displayed in a tab content 922.

FIG. 9C illustrates a user interface 940 from the perspective of a presenting participant who is actively sharing content within a video conference. The tab 902C, when selected, corresponds (e.g., causes to be displayed) content shared by the presenting participant themselves. As such, from the perspective of the presenting participant (e.g., the presenting participant with the initial “AB”), the tab content 922 is in fact showing a content stream of content displayed in the window of the spreadsheet editing application itself (not shown).

The tab content 922 is overlaid with a transparent overlay layer (e.g., an overlay 924) that at least partially obscures the tab content 922 indicating to the presenting participant that the tab content 922 corresponds to content shared by them. A message 926 informs the presenting participant with the notification “YOU ARE SHARING YOUR SPREADSHEET EDITING APPLICATION,” confirming the active sharing status and identifying the content that other participants are viewing.

The overlay 924 includes a control 928 labeled “STOP SHARING” and a control 930 labeled “GO TO WINDOW.” In response to the presenting participant invoking (e.g., clicking) the control 928, the client conferencing software terminates the sharing of the spreadsheet application, ceasing the broadcast of the spreadsheet content to other conference participants. In response to invoking the control 930, the client conferencing software causes the application window corresponding to the shared spreadsheet to be brought to the forefront on the display of presenting device, allowing the presenting participant to directly interact with and edit the content of the spreadsheet.

It should be noted that while the shared content is visible to other participants in its current state in the tab content 922, the content is not editable through this view. Any edits or interactions with the shared spreadsheet by the presenting participant occurs in the actual spreadsheet application window, which can be accessed by using control 930.

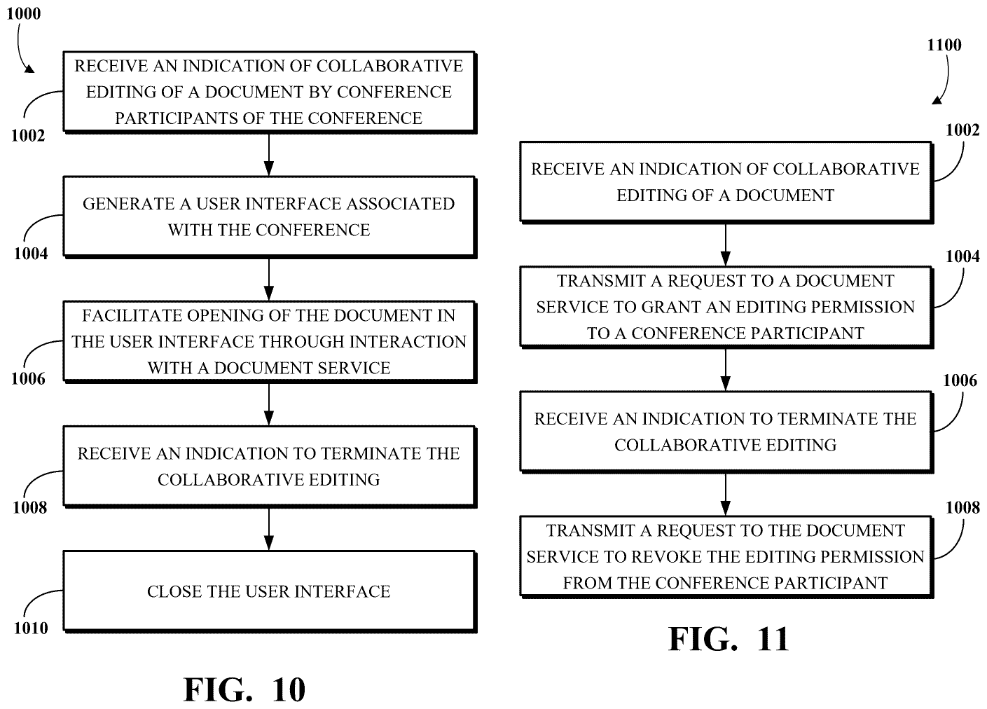

To further describe some implementations in greater detail, reference is next made to examples of techniques which may be performed by or using a system for multi-content sharing and collaborative editing in conferences. FIG. 10 is a flowchart of an example of a technique 1000 for collaborative document editing in a conference. The technique 1000 can be executed using computing devices, such as the systems, hardware, and software described with respect to FIGS. 1-9C. The technique 1000 can be performed by a presenting device, such as the presenting device 504 of FIG. 5. The technique 1000 can be implemented by a client conferencing software, such as the client conferencing software 600 of FIG. 6. The technique 1000 can be performed, for example, by executing a machine-readable program or other computer-executable instructions, such as routines, instructions, programs, or other code. The steps, or operations, of the technique 1000, or another technique, method, process, or algorithm described in connection with the implementations disclosed herein can be implemented directly in hardware, firmware, software executed by hardware, circuitry, or a combination thereof.

At 1002, an indication of collaborative editing of a document by conference participants of the conference is received. The indication of the collaborative editing can be received in response to the presenting device selecting a document to share for collaborative editing, as described with respect to FIG. 8B. The indication of the collaborative editing may include data specifying the document, such as a document name, a document path, or a document URL. The data specifying the document may include a document service that manages the document. Collaborative editing can be initiated by a conference participant (e.g., a presenting participant).

The conference participants that are to collaboratively edit the document can be all of the conference participants or can be a subset of the all of the conference participants. In an example, a first input may be received indicating to associate an editing permission with the conference participants and a second input to associate a reviewing permission with another conference participant that is different form the conference participants. In response to the inputs, one or more requests are transmitted to the document service (using APIs of the document service) to associate the editing permission and the reviewing permission. As described above, the document service can be a cloud-based platform.

The document can be selected from a list of available documents at the document service. The list of the available documents may be retrieved from the document service and displayed in a user interface, which can be the file selector 840 of FIG. 8B. A selection of the document may then be received.

At 1004, a user interface associated with the conference is generated for displaying the document. For example, and as described above, a container may be created. At 1006, the techniques 1000 facilitates opening of the document in the user interface through interaction with the document service. As described above, the technique 1000 can cause the document server to render the document in the container. As described above, a user interface associated with the conferencing software may be tabbed user interface where each share content or document may be displayed in a tab. As such, the user interface that includes the document may be presented within a dedicated tab of the conferencing software.

At 1006, an identity of at least one of conference participants associated with the device may be authenticated prior to facilitating to the opening of the document. At 1008, an indication to terminate the collaborative editing is received. For example, the presenting participant may explicitly terminate the collaboration session. In another example, a termination of the conference can be the indication to terminate the collaborative editing. At 1010, in response to the indication to terminate the collaborative editing, the user interface is closed. For example, the container may be closed (e.g., destroyed).

As described above, prior to displaying the document for editing in a user interface at a client device of one of the conference participants, the conference participant may be prompted to provide their credentials so that the document service can authenticate the identity of the conference participant associated with the client device prior to facilitating to the opening of the document.

FIG. 11 is a flowchart of an example of a technique 1100 for collaborative sharing of document in a conference. The technique 1100 can be executed using computing devices, such as the systems, hardware, and software described with respect to FIGS. 1-9C. The technique 1100 can be implemented at least in part by a conferencing software, such as the conferencing software 508 of FIG. 5 or the conferencing software 700 of FIG. 7. As such, the technique 1100 can be performed by a server, such as the server 502 of FIG. 5. The technique 1100 can be implemented at least in part by a client conferencing software, such as the client conferencing software 512 of FIG. 5 or the client conferencing software 600 of FIG. 6. As such the technique 1100 can be performed by a presenting device, such as the presenting device 504 of FIG. 5.

The technique 1100 can be performed, for example, by executing a machine-readable program or other computer-executable instructions, such as routines, instructions, programs, or other code. The steps, or operations, of the technique 1100, or another technique, method, process, or algorithm described in connection with the implementations disclosed herein can be implemented directly in hardware, firmware, software executed by hardware, circuitry, or a combination thereof.

At 1102, an indication of collaborative editing of a document by conference participants of a conference is received. The conference participants may be all or a subset of all of the conference participants of the conference. In an example, some conference participants may be designated as editing participants and some other participants may be designated as reviewing participants. The indication may be received such as described above. The indication may be received at a presenting device and communicated to the server.

At 1104, the server transmits a request to a document service that manages the document to grant an editing permission to one of the conference participants. For example, the server may transmit requests to the document service to grant the editing permission to each of the conference participants. The document service can be one a cloud-based document management system. For example, the document service can be one of Google Docs, Microsoft Office Online, or Dropbox Paper. The server maintains a list of document services usable by the server for the collaborative editing. That is, the server may be configured (e.g., programmed) to integrate (e.g., communicate) with the document services to provide collaborative editing.

At 1106, and at some later time in the conference, the server receives (e.g., identifies) an indication to terminate the collaborative editing. For example, the server may determine that the conference has terminated. In another example, the server may receive the indication from the presenting device that the presenting participant has terminated the collaborative editing. At 1108, the server transmits a request to the document service to revoke the editing permission from the conference participant. In an example, in response to receiving the indication to terminate the collaborative editing, a confirmation prompt of the indication to terminate the collaborative editing may be provided to the at least one of the conference participants. For example, the server may transmit the indication to terminate the collaborative editing to respective clients of participants currently editing the document. Said another way, the server may transmit to a client device a command to a display the confirmation prompt indicating the termination of the collaborative editing session. Respective confirmation prompts can then be displayed by the clients.

In an example, the server may transmit a request to the document service to obtain an original permission associated with the conference participant of the conference with respect to the document. The server may then transmit a request to the document service to grant the editing permission to the one of the conference participants. The server may later, such as in response to the indication to terminate the collaborative editing, transmit a request to set a permission of the conference participant to the original permission with respect to the document. As such, the server may transmit a request to the document service to reset the permission of the conference participants to the original permission that existed prior to the first request.

For simplicity of explanation, the techniques 1000 and 1100 of FIGS. 10 and 11, respectively, are each depicted and described herein as a respective series of steps or operations. However, the steps or operations of the techniques 1000 and 1100 in accordance with this disclosure can occur in various orders and/or concurrently. Additionally, other steps or operations not presented and described herein may be used. Furthermore, not all illustrated steps or operations may be required to implement a technique in accordance with the disclosed subject matter.

An identifier (e.g., a link) to the document can be transmitted to a client. The identifier may be transmitted with a request to open the document at the client. In response to receiving the request, the client can communicate with the document service to cause the document service to open the document for editing at the client. For example, the client may create a container (e.g., an iframe) and cause the document service to render the document for editing in the container.

In an example, the server may receive a request from a client for a list of available documents at the document service. The server, in turn, can request the list from the document service and transmit the list of the available documents to the client. As mentioned above, the list of available documents can include only those documents to which the presenting participant has the permissions to modify permission.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

One general aspect includes a method. The method includes receiving, by a server, an indication of collaborative editing of a document by conference participants of a conference; transmitting, by the server, a first request to a document service that manages the document to grant an editing permission to at least one of the conference participants; receiving, by the server, an indication to terminate the collaborative editing; and, in response to the indication to terminate the collaborative editing, transmitting, by the server, a second request to the document service to revoke the editing permission from the at least one of the conference participants. Other embodiments of this aspect include corresponding computer systems, apparatus, and computer programs recorded on one or more computer storage devices, each configured to perform the actions of the methods.

Implementations may include one or more of the following features.

The method may include transmitting a backup request of the document to the document service.

The method may include transmitting, by the server and prior to an initiation of the collaborative editing, a third request to the document service to obtain an original permission associated with the at least one of the conference participants with respect to the document; and in response to the indication to terminate the collaborative editing, transmitting, by the server, a fourth request to reset a permission of the one of the conference participants to the original permission with respect to the document.

The method may include transmitting, by the server to a client device associated with the at least one of the conference participants, a link to the document.

The method may include obtaining, by the server, a list of available documents from the document service; and transmitting the list of the available documents to a client device. The method may include transmitting, by the server to a client device, a command to display a confirmation prompt indicating the termination of the collaborative editing.

The document service can be a cloud-based platform.

Implementations of the described techniques may include hardware, a method or process, or computer software on a computer-accessible medium.

One general aspect includes a server that includes one or more memories and one or more processors. The one or more processors configured to execute instructions stored in the one or more memories to receive, by the server, an indication of collaborative editing of a document by conference participants of a conference; transmit, by the server, a first request to a document service that manages the document to grant an editing permission to at least one of the conference participants; receive, by the server, an indication to terminate the collaborative editing; and in response to the indication to terminate the collaborative editing, transmit, by the server, a second request to the document service to revoke the editing permission from the at least one of the conference participants. Other embodiments of this aspect include corresponding computer systems, apparatus, and computer programs recorded on one or more computer storage devices, each configured to perform the actions of the methods.

Implementations may include one or more of the following features.

The instructions to transmit, by the server, the second request to the document service to revoke the editing permission from the at least one of the conference participants may include to transmit a request to reset the permission of the at least one of the conference participants to an original permission that existed prior to the first request.

The one or more processors can be configured to execute instructions stored in the one or more memories to, in response to receiving the indication to terminate the collaborative editing, provide a confirmation prompt of the indication to terminate the collaborative editing to the at least one of the conference participants.

The one or more processors can be configured to execute instructions stored in the one or more memories to transmit a backup request of the document to the document service.

The one or more processors can be configured to execute instructions stored in the one or more memories to receive, from a client device, a request for a list of document services that the server is integrated with; and transmit, to the client device, the list of the document services.

The document service can be one of Google Docs, Microsoft Office Online, or Dropbox Paper.

The one or more processors can be configured to execute instructions stored in the one or more memories to transmit a request to the document service to trigger a display of a file selector of the document service.

One general aspect includes one or more non-transitory computer readable media storing instructions operable to cause one or more processors to perform operations. The operations include receiving, by a server, an indication of collaborative editing of a document by conference participants of a conference; transmitting, by the server, a first request to a document service that manages the document to grant an editing permission to at least one of the conference participants; receiving, by the server, an indication to terminate the collaborative editing; and, in response to the indication to terminate the collaborative editing, transmitting, by the server, a second request to the document service to revoke the editing permission from the at least one of the conference participants.

Implementations may include one or more of the following features.

The one or more non-transitory computer readable media where the document service is a cloud-based document management system.

The operations may include, in response to the indication to terminate the collaborative editing, transmitting, by the server, a request to reset a permission of the at least one of the conference participants with respect to the document to an initial permission that existed prior to a start of the collaborative editing.

The operations may include transmitting, by the server to the document service, a request to generate a new version of the document.

The operations may include transmitting a list of available documents obtained from the document service to a client device.

The server may maintain a list of document services usable by the server for the collaborative editing.

As used herein, unless explicitly stated otherwise, any term specified in the singular may include its plural version. For example, “a computer that stores data and runs software,” may include a single computer that stores data and runs software or two computers-a first computer that stores data and a second computer that runs software. Also “a computer that stores data and runs software,” may include multiple computers that together stored data and run software. At least one of the multiple computers stores data, and at least one of the multiple computers runs software.

As used herein, the term “computer-readable medium” encompasses one or more computer readable media. A computer-readable medium may include any storage unit (or multiple storage units) that store data or instructions that are readable by processing circuitry. A computer-readable medium may include, for example, at least one of a data repository, a data storage unit, a computer memory, a hard drive, a disk, or a random-access memory. A computer-readable medium may include a single computer-readable medium or multiple computer-readable media. A computer-readable medium may be a transitory computer-readable medium or a non-transitory computer-readable medium.

As used herein, the term “memory subsystem” includes one or more memories, where each memory may be a computer-readable medium. A memory subsystem may encompass memory hardware units (e.g., a hard drive or a disk) that store data or instructions in software form. Alternatively, or in addition, the memory subsystem may include data or instructions that are hard-wired into processing circuitry.

As used herein, processing circuitry includes one or more processors. The one or more processors may be arranged in one or more processing units, for example, a central processing unit (CPU), a graphics processing unit (GPU), or a combination of at least one of a CPU or a GPU.

As used herein, the term “engine” may include software, hardware, or a combination of software and hardware. An engine may be implemented using software stored in the memory subsystem. Alternatively, an engine may be hard-wired into processing circuitry. In some cases, an engine includes a combination of software stored in the memory subsystem and hardware that is hard-wired into the processing circuitry.

The implementations of this disclosure can be described in terms of functional block components and various processing operations. Such functional block components can be realized by a number of hardware or software components that perform the specified functions. For example, the disclosed implementations can employ various integrated circuit components (e.g., memory elements, processing elements, logic elements, look-up tables, and the like), which can carry out a variety of functions under the control of one or more microprocessors or other control devices. Similarly, where the elements of the disclosed implementations are implemented using software programming or software elements, the systems and techniques can be implemented with a programming or scripting language, such as C, C++, Java, JavaScript, assembler, or the like, with the various algorithms being implemented with a combination of data structures, objects, processes, routines, or other programming elements.

Functional aspects can be implemented in algorithms that execute on one or more processors. Furthermore, the implementations of the systems and techniques disclosed herein could employ a number of conventional techniques for electronics configuration, signal processing or control, data processing, and the like. The words “mechanism” and “component” are used broadly and are not limited to mechanical or physical implementations, but can include software routines in conjunction with processors, etc. Likewise, the terms “system” or “tool” as used herein and in the figures, but in any event based on their context, may be understood as corresponding to a functional unit implemented using software, hardware (e.g., an integrated circuit, such as an ASIC), or a combination of software and hardware. In certain contexts, such systems or mechanisms may be understood to be a processor-implemented software system or processor-implemented software mechanism that is part of or callable by an executable program, which may itself be wholly or partly composed of such linked systems or mechanisms.

Implementations or portions of implementations of the above disclosure can take the form of a computer program product accessible from, for example, a computer-usable or computer-readable medium. A computer-usable or computer-readable medium can be a device that can, for example, tangibly contain, store, communicate, or transport a program or data structure for use by or in connection with a processor. The medium can be, for example, an electronic, magnetic, optical, electromagnetic, or semiconductor device.

Other suitable mediums are also available. Such computer-usable or computer-readable media can be referred to as non-transitory memory or media, and can include volatile memory or non-volatile memory that can change over time. The quality of memory or media being non-transitory refers to such memory or media storing data for some period of time or otherwise based on device power or a device power cycle. A memory of an apparatus described herein, unless otherwise specified, does not have to be physically contained by the apparatus, but is one that can be accessed remotely by the apparatus, and does not have to be contiguous with other memory that might be physically contained by the apparatus.

While the disclosure has been described in connection with certain implementations, it is to be understood that the disclosure is not to be limited to the disclosed implementations but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A method, comprising:
receiving, by a server, an indication of collaborative editing of a document by conference participants of a conference;
transmitting, by the server, a first request to a document service that manages the document to grant an editing permission to at least one of the conference participants;
receiving, by the server, an indication to terminate the collaborative editing; and
in response to the indication to terminate the collaborative editing, transmitting, by the server, a second request to the document service to revoke the editing permission from the at least one of the conference participants.

2. The method of claim 1, further comprising:
transmitting a backup request of the document to the document service.

3. The method of claim 1, further comprising:
transmitting, by the server and prior to an initiation of the collaborative editing, a third request to the document service to obtain an original permission associated with the at least one of the conference participants with respect to the document; and
in response to the indication to terminate the collaborative editing, transmitting, by the server, a fourth request to reset a permission of the one of the conference participants to the original permission with respect to the document.

4. The method of claim 1, further comprising:
transmitting, by the server to a client device associated with the at least one of the conference participants, a link to the document.

5. The method of claim 1, further comprising:
obtaining, by the server, a list of available documents from the document service; and
transmitting the list of the available documents to a client device.

6. The method of claim 1, further comprising:
transmitting, by the server to a client device, a command to display a confirmation prompt indicating the termination of the collaborative editing.

7. The method of claim 1, wherein the document service is a cloud-based platform.

8. A server, comprising:
one or more memories; and
one or more processors, the one or more processors configured to execute instructions stored in the one or more memories to:
receive, by the server, an indication of collaborative editing of a document by conference participants of a conference;
transmit, by the server, a first request to a document service that manages the document to grant an editing permission to at least one of the conference participants;
receive, by the server, an indication to terminate the collaborative editing; and
in response to the indication to terminate the collaborative editing, transmit, by the server, a second request to the document service to revoke the editing permission from the at least one of the conference participants.

9. The server of claim 8, wherein the instructions to transmit, by the server, the second request to the document service to revoke the editing permission from the at least one of the conference participants comprise to:
transmit a request to reset the permission of the at least one of the conference participants to an original permission that existed prior to the first request.

10. The server of claim 8, wherein the one or more processors are further configured to execute instructions stored in the one or more memories to:
in response to receiving the indication to terminate the collaborative editing, provide a confirmation prompt of the indication to terminate the collaborative editing to the at least one of the conference participants.

11. The server of claim 8, wherein the one or more processors are configured to execute instructions stored in the one or more memories to:
transmit a backup request of the document to the document service.

12. The server of claim 8, wherein the one or more processors are configured to execute instructions stored in the one or more memories to:
receive, from a client device, a request for a list of document services that the server is integrated with; and
transmit, to the client device, the list of the document services.

13. The server of claim 8, wherein the document service is one of Google Docs, Microsoft Office Online, or Dropbox Paper.

14. The server of claim 8, wherein the one or more processors are configured to execute instructions stored in the one or more memories to:
transmit a request to the document service to trigger a display of a file selector of the document service.

15. One or more non-transitory computer readable media storing instructions operable to cause one or more processors to perform operations comprising:
receiving, by a server, an indication of collaborative editing of a document by conference participants of a conference;
transmitting, by the server, a first request to a document service that manages the document to grant an editing permission to at least one of the conference participants;
receiving, by the server, an indication to terminate the collaborative editing; and
in response to the indication to terminate the collaborative editing, transmitting, by the server, a second request to the document service to revoke the editing permission from the at least one of the conference participants.

16. The one or more non-transitory computer readable media of claim 15, wherein the document service is a cloud-based document management system.

17. The one or more non-transitory computer readable media of claim 15, wherein the operations further comprise:
in response to the indication to terminate the collaborative editing, transmitting, by the server, a request to reset a permission of the at least one of the conference participants with respect to the document to an initial permission that existed prior to a start of the collaborative editing.

18. The one or more non-transitory computer readable media of claim 15, wherein the operations further comprise:
transmitting, by the server to the document service, a request to generate a new version of the document.

19. The one or more non-transitory computer readable media of claim 15, wherein the operations further comprise:
transmitting a list of available documents obtained from the document service to a client device.

20. The one or more non-transitory computer readable media of claim 15, wherein the server maintains a list of document services usable by the server for the collaborative editing.
